(19) United States
(12) Patent Application Publication
(10) Pub. No.: US 2007/0141530 A1
(43) Pub. Date: Jun. 21, 2007

(54) Portable vacuum veneer placement instrument

(76) Inventor: Neil John Graham, Long Beach, CA (US)

Correspondence Address: Neil John Graham, 6017 Lido Lane, Long Beach, CA, 90803, US

(21) Appl. No.: 11/302,648

(22) Filed: Dec. 15, 2005

(51) Int. Cl. A61C 3/00

(52) U.S. Cl. 433/163

(57) ABSTRACT

The present invention is directed to a device for vacuum holding a dental veneer during the trial placement of a veneer on a tooth, application of adhesive to the veneer and final placement of the veneer on the tooth. The device includes a flexible suction cup with a connecting air bulb. The cup is placed on the external surface of the veneer while squeezing the air bulb. The veneer is held on the cup until the air bulb is squeezed. The instrument allows for multiple veneers to be simultaneously coated and placed,

### FIELD OF THE INVENTION

The present invention relates generally to an instrument for manipulating and placing dental restorations, such as dental veneers on a patient's teeth.

### BACKGROUND OF THE INVENTION

This invention relates generally to an instrument for use in facilitated handling of fragile dental veneers to permit fitting of the veneer, application of adhesive to the veneer and placement of the veneer on a tooth in a time-efficient manner. A dental veneer commonly comprises a thin-walled dental prosthetic fitted to the labial surface of a tooth, the veneer having an external geometry with a color typically selected to match adjacent natural or veneered teeth in the patient's mouth. The veneers are constructed from composite materials or porcelain. Modernly, porcelain is the material of choice due to its color stability and resistance to abrasion. The thin-walled porcelain veneer has an interior convex surface prepared by acid etching or the like for secure bonding onto a patient's tooth. The surface of the tooth is similarly prepared by acid etching A bonding agent is applied to the veneer-tooth interface to securely hold the veneer in place.

Despite the popularity of dental veneers, fitting and fixation of a dental veneer within the mouth of a patient tends to be a difficult and time-consuming procedure. The dental veneer is prefabricated by a laboratory and must then be trial fitted on the tooth and checked for fit, shape and color. A typical veneer has an average thickness of 0.5 mm. making it relatively fragile. Extreme care must be exercised in handling the veneer. Dropping the veneer could easily break it. After trial fitting, the dental veneer is removed from the patient's mouth and the bonding agent seal is applied typically to the interior acid etched concave surface of the porcelain veneer and the labial surface of the patient's tooth where it is light cured. Light curing adhesive is placed on the internal surface of the veneer wherein the veneer is carried to the tooth where it is light cured to the tooth. A light curable bonding agent responsive to selected visible light spectra is popularly used, since it permits final fitting adjustments by the dentist without concern for premature curing of the bonding agent. When a final fit is achieved, the dentist applies a source of the selected light spectra to the veneer to cure the bonding agent. The foregoing procedure for dental veneer positioning and fixation unfortunately tends to be difficult, tedious and time consuming. The dental veneer is small and fragile and can be permanently damaged if dropped. Current use of surgical gloves by dentists and assistants makes handling of the veneers even more difficult. There exists a significant need for improvements in the handling and installation of fragile dental veneers, to permit rapid and accurate veneer fitting and fixation while improving the visibility of the veneer and the installation site throughout an installation.

Oliva U.S. Pat. No. 4,822,278 discloses an instrument for handling veneers with a disposable resilient plastic transparent tip attached to a vacuum source. The requirement of a line with a vacuum source does not lend itself to placing multiple restorations efficiently, essentially simultaneously.

Oliva U.S. Pat. No. 5,040,981 discloses an elongated pencil-like handle structure having a tip which is releasably attached to a surface of a veneer. A tip plate with a tacky substance with sufficient adherence is coated on the tip to secure the veneer. The strength of the adhesion is critical. Too much adhesion would remove the laminate after it is bonded to the tooth. The problem is the release takes a certain amount of pressure to release the veneer.

Riihinaki U.S. Pat. No. 5,256,064 disclosed an instrument with a removable disposable double-stick pad with pressure sensitive adhesive coated on opposite sides. The hope is the sticky tape will hold the veneer when needed and will release without dislodging the restoration.

See U.S. Pat. No. 5,669,711 disclosed a small thin flat tab which is glued with a hot melt adhesive to the external surface of the veneer. The suggestion is that the external surface of the veneer is coated with a primer to facilitate removal of the instrument after the veneer is attached to the tooth.

Lee discloses a box with multiple mounts for the tabs. A box cover is disclosed which prevents light in the wave length that would curie the adhesive prior to placing the veneers on the patient's teeth.

Rathbauer U.S. Pat. No. 6,182,820, discloses a box with holders for multiple veneers. The box has a lid which, when closed, blocks all light which may cure the adhesion on the veneers prior to placing the veneers on the teeth.

Because of the cost and fragility of ceramic tooth veneers, and the precision with which they must be placed on a tooth in the lamination process, it would seem desirable to provide a device for holding manipulating a ceramic veneer, especially during the placement of the veneer on a tooth during the adhesive bonding of the veneer to the tooth Some relatively complex vacuum-holding devices have been proposed for use with ceramic dental veneers. A need exists for an efficient low-cost device for manipulating veneers wherein multiple veneers can be placed simultaneously.

### SUMMARY OF INVENTION

The present mention is directed to a portable vacuum veneer placement instrument for holding a dental veneer during its manipulation and placement in a person's mouth. The portable vacuum veneer placement instrument is comprised of a vacuum air bulb with an attached small flexible cup. The flexible cup is placed on the outer surface of a veneer while the air bulb is squeezed. The veneer will stay attached until the air bulb is squeezed again. The instrument will release from the veneer with no pressure. The portable vacuum veneer placement instrument may be made very inexpensively; therefore, is disposable. Receptacles in the floor of the box receive the vacuum bulb which will stand upright with the flexible cup facing upwards. Multiple veneers may be placed efficiently, each on an instrument and placed in order

### BRIEF DESCRIPTION OF THE DRAWINGS

FIG. 1 is a side plan view of the portable vacuum veneer placement instrument;

FIG. 2 is a perspective view of squeezing the placement instrument air bulb in order to attach a veneer;

FIG. 3 is a perspective view a veneer being placed upon a tooth;

FIG. 4 is a perspective front view of the instrument disclosing the vacuum cup;

FIG. 5 is a side elevation disclosing the vacuum cup;

FIG. 6 is a front radiation front end elevation of the front tip;

FIG. 7 is a perspective view of the placement instrument holder;

FIG. 8 is a perspective view of the placement tool holder with the placement tools;

FIG. 9 is a perspective view of the placement tool holder within a light-proof box;

FIG. 10 is a perspective view of FIG. 9 with the placement instruments;

FIG. 11 is a side elevation of the placement instrument with a bend in the shaft portion; and

FIG. 12 is a side elevation view of the placement instrument a FIG. 11 wherein the suction tip is placed at a right angle to the shaft.

### DETAILED DESCRIPTION OF THE INVENTION

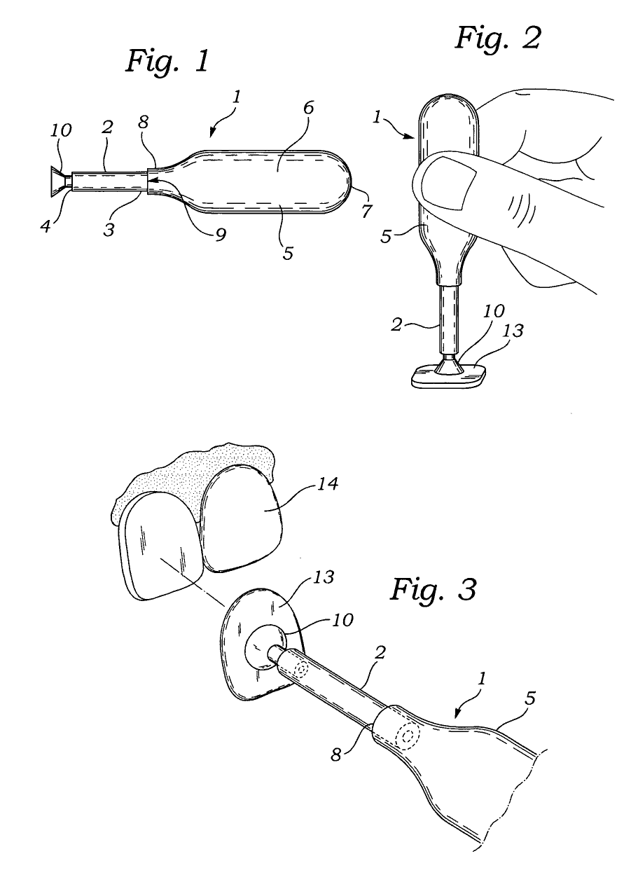

Referring to FIG. 1 the portable vacuum veneer placement instrument 1 has an axial longitudinal tube 2 with first 3 and second 4 ends. The axial longitudinal tube 2 has a hollow interior extending from its first end 3 to its second end 4. Attached to the first end 3 of the axial longitudinal tube 2 is an air bulb 5 with a hollow interior 6, a rear end 7, and a front end 8 defining an internal passage 9 connecting to the hollow interior of the axial longitudinal tube 2. A tip 10 is attached to the second end 4 of the axial longitudinal tube 2. As shown in FIG. 2 the portable vacuum veneer placement instrument 1 is attached to the surface of a dental veneer 13 by placing the tip 10 on the surface of adrenal veneer 13 and squeezing the air bulb 5 which vacuum attaches the dental veneer 13 to the tip 10. The attached dental veneer 13, as shown in FIG. 3 is then carried to the surface of a patient's tooth 14.

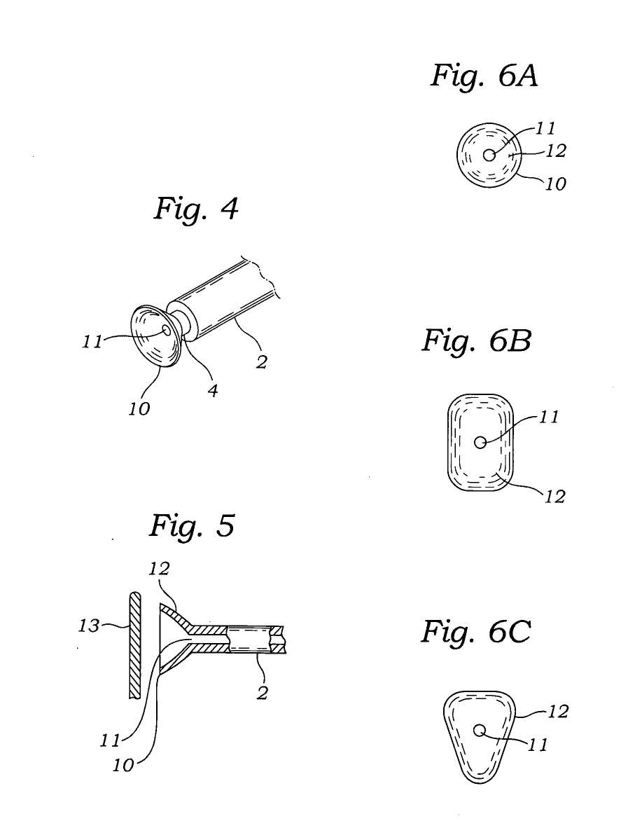

In FIGS. 4 and 5 the tip 10 is shown with an interior channel 11 which communicates with the hollow interior of the axial longitudinal tube 2 the tip being formed from a resilient elastomer and defining an outwardly opening cup-shaped base 12 for engaging the dental veneer 13,

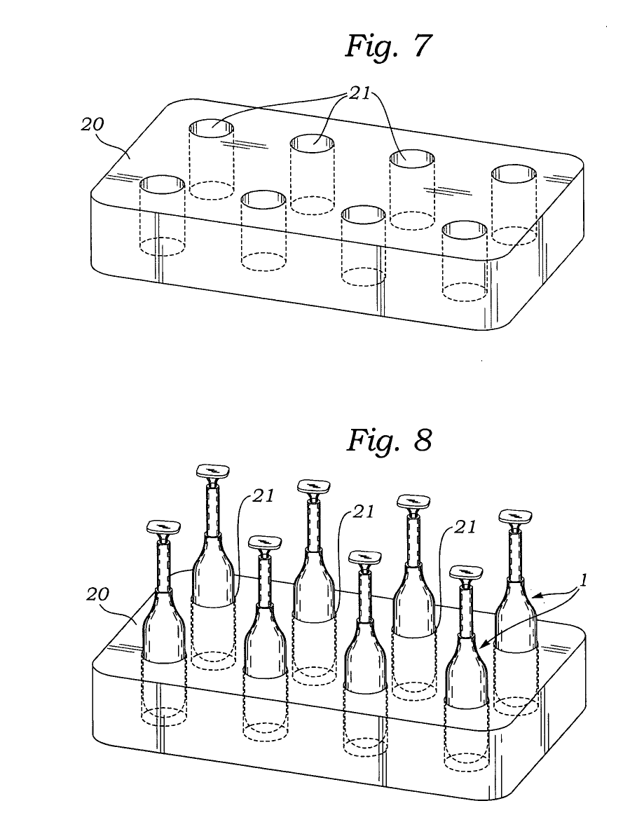

In a preferred embodiment the cup-shaped base 12 is shown in FIG. 6 A in a circular shape. The diameter of the cup 12 ideally is 4-6 mm. which is less than the mesial-distal width of an average tooth. FIG. 6B shows another preferred embodiment of the cup 12 wherein the shape is rectangular which more closely conforms with the shape of a dental veneer 13 as shown in FIG. 3.

FIG. 6C shows another embodiment of the cup 12 wherein the cup is rhomboid, almost triangular in shape. The rhomboid shape is very useful for securing a veneer used on a lower anterior tooth. The labial surface of teeth are narrower at the gum line as compared to the incisal edge which is especially true of the lower anterior teeth,

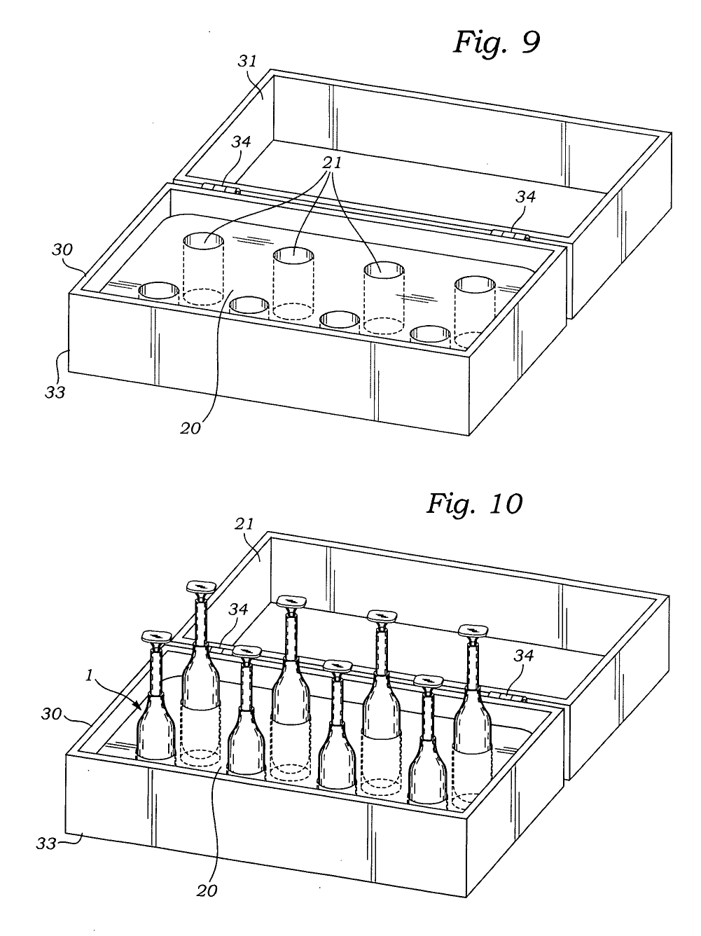

FIGS. 7-8 show a tool holder 20 for the tool 1. The tool holder 20 contains recesses 21 sized to receive the air bulb 5 of the tool 1. The tools are inserted vertically with a veneer 13 placed on each tool 1 tip 10. Each veneer 13 can be carried to its respective tooth for fitting. As shown in FIG. 10, each veneer 13 with its tool 1 is then returned to the holder where light cured glue is coated on each veneer 13 in preparation for permanently bonding the veneer 13 to the patient's tooth 14. Multiple veneers 13 may be placed very efficiently using the present invention. Multiple veneers 13 are placed with their respective tools 1 as shown in FIGS. 8 and 10. Each veneer 13 is then carried to its respective tooth and checked for fit. FIGS. 9 and 19 solve the overhead light hardening problem. The veneers 13 are then returned to the holder 20 where all veneers 13 are then coated with light cured adhesive. The overhead lighting curing problem is solved by enclosing the veneers 13 within a light insulated box 30 as shown in FIGS. 9 and 10. The box is comprised of a lid 31 connected by hinges 34 to a base 33.

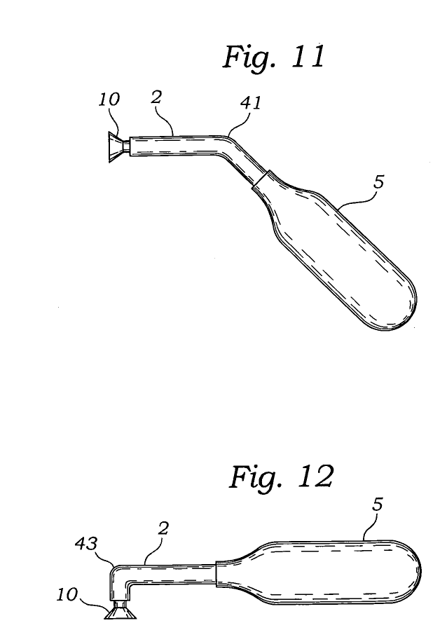

FIG. 11 shows a tube 2 with a 45 degree bend 41 which might enhance visibility of the veneer 13 while it is being held on the tooth with the tool 1. FIG. 12 shows a tube 2 with a 90 degree bend which is advantageous for placing a restoration on a posterior tooth.

What is claimed:

1. A portable vacuum veneer placement instrument for placing a dental veneer on a tooth comprising:
a straight axial longitudinal tube with a first end, second end, and an exterior and an interior wherein the longitudinal tube interior is hollow and extends from the first end to the second end;
an air bulb with a hollow interior having front and rear ends, the front end defining an internal passage, the air bulb front end is connected to the axial longitudinal tube first end wherein the air bulb internal passage connects with the hollow interior of the longitudinal tube; and
a tip with an interior channel mounted at the second end of the axial longitudinal tube, the tip being 4 mm-6 mm in diameter formed from a resilient elastomer and defining an outwardly opening cup-shaped base for engaging the dental veneer, the interior of the cup-shaped base being in communication with the tip interior channel which communicates with the hollow interior of the axial tube whereby the dental veneer is vacuum supported against the cup-shaped base when the air bulb is squeezed.

2. The portable vacuum veneer placement instrument according to claim 1 wherein the cup-shaped base of the tip is circular in shape.

3. The portable vacuum veneer placement instrument according to claim 1 wherein the cup-shaped base of the tip is rectangular in shape.

4. The portable vacuum veneer placement instrument according to claim 1 wherein the cup-shaped base of the tip is trapezoidal in shape which conforms with the labial shape of a lower anterior tooth.

5. The portable vacuum veneer placement instrument according to claim 1 wherein a tool holder is included, the tool holder is comprised of holes sized to receive the portable vacuum veneer placement Instruments in an upright manner.

6. The portable vacuum veneer placement instrument according to claim 1 wherein a tool holder contained within a light proof box is included, the tool holder is comprised of holes sized to receive the portable vacuum veneer placement instruments in an upright manner and the box is hinged allowing the portable vacuum veneer placement instruments containing veneers to be placed in the holes for placement of light curing adhesives to be applied to the inner surfaces of the veneers, closure of the lid blocks out light which prevents curing of the light cure adhesive until the veneers are placed upon their respective teeth.

7. A portable vacuum veneer placement instrument for placing a dental veneer on a tooth comprising:
an axial longitudinal tube with a first end, second end, an exterior, an interior and a longitudinal bend having a magnitude in the range of 30 degrees to 45 degrees wherein the longitudinal tube interior is hollow and extends from the first end to the second end;
an air bulb with a hollow interior having front and rear ends, the front end defining an internal passage, the air bulb front end is connected to the axial longitudinal tube first wherein the air bulb internal passage connects with the hollow interior of the longitudinal tube; and
a tip with an interior channel mounted at the second end of the axial longitudinal tube, the tip being 4 mm-6 mm in diameter formed from a resilient elastomer and defining an outwardly opening cup-shaped base for engaging the dental veneer, the interior of the cup-shaped base being in communication with the tip interior channel which communicates with the hollow interior of the axial tube whereby the dental veneer is vacuum supported against the cup-shaped base when the air bulb is squeezed.

8. The portable vacuum veneer placement instrument according to claim 7 wherein the cup-shaped base of the tip is circular in shape.

9. The portable vacuum veneer placement instrument according to claim 7 wherein the cup-shaped base of the tip is rectangular in shape.

10. The portable vacuum veneer placement instrument according to claim 7 wherein the cup-shaped base of the tip is trapezoidal in shape which conforms with the labial shape of a lower anterior tooth.

11. The portable vacuum veneer placement instrument according to claim 7 wherein a tool holder is included, the tool holder is comprised of holes sized to receive the portable vacuum veneer placement Instruments in an upright manner.

12. The portable vacuum veneer placement instrument according to claim 7 wherein a tool holder contained within a light proof box is included, the tool holder is comprised of holes sized to receive the portable vacuum veneer placement Instruments in an upright manner and the box is hinged allowing the portable vacuum veneer placement instruments containing veneers to be placed in the holes for placement of light curing adhesives to be applied to the inner surfaces of the veneers, closure of the lid blocks out light which prevents curing of the light cure adhesive until the veneers are placed upon their respective teeth.

13. A portable vacuum veneer placement instrument for placing a dental veneer on a tooth comprising:
an axial longitudinal tube with a first end, second end, an exterior, an interior and a longitudinal 90 degree bend wherein the longitudinal tube interior is hollow and extends from the first end to the second end;
an air bulb with a hollow interior having front and rear ends, the front end defining an internal passage, the air bulb front end is connected to the axial longitudinal tube first wherein the air bulb internal passage connects with the hollow interior of the longitudinal tube; and
a tip with an interior channel mounted at the second end of the axial longitudinal tube, the tip being 4 mm-6 mm in diameter formed from a resilient elastomer and defining an outwardly opening cup-shaped base for engaging the dental veneer, the interior of the cup-shaped base being in communication with the tip interior channel which communicates with the hollow interior of the axial tube whereby the dental veneer is vacuum supported against the cup-shaped base when the air bulb is squeezed.

14. The portable vacuum veneer placement instrument according to claim 13 wherein the cup-shaped base of the tip is circular in shape.

15. The portable vacuum veneer placement instrument according to claim 13 wherein the cup-shaped base of the tip is rectangular in shape.

16. The portable vacuum veneer placement instrument according to claim 13 wherein the cup-shaped base of the tip is trapezoidal in shape which conforms with the labial shape of a lower anterior tooth.

17. The portable vacuum veneer placement instrument according to claim 13 wherein a tool holder is included, the tool holder is comprised of holes sized to receive the portable vacuum veneer placement Instruments in an upright manner.

18. The portable vacuum veneer placement instrument according to claim 13 wherein a tool holder contained within a light proof box is included, the tool holder is comprised of holes sized to receive the portable vacuum veneer placement Instruments in an upright manner and the box is hinged allowing the placement of the portable vacuum veneer placement instruments containing veneers to be placed in the holes for placement of light curing adhesives to be applied to the inner surfaces of the veneers, closure of the lid blocks out light which prevents curing of the light cure adhesive until the veneers are placed upon their respective teeth.

19. A method of handling a dental restoration, during its fitting and final cementation to a tooth comprising:
placing a tip of a portable vacuum veneer placement instrument on an outer surface of the dental restoration,
squeezing an air bulb of the portable vacuum veneer placement instrument in order to vacuum attach the dental restoration to the tip of the portable vacuum veneer placement instrument
carrying the denial restoration to the tooth for sizing;
coating an inner surface of the dental restoration with a light-curing adhesive;
seating the inner surface of the dental restoration on the tooth;
curing the adhesive with a light-curing light; and
squeezing the air bulb of the portable vacuum veneer placement instrument which releases the portable vacuum veneer placement instrument from the dental restoration.

20. A method of handling a dental restoration during its fitting and final cementation to a tooth according to claim 19 including placing the veneer while mounted to the portable vacuum veneer placement instrument into an instrument holder contained within a light insulated box and closing the lid so as to prevent curing of the adhesive.
